(19) United States
(12) Patent Application Publication
(10) Pub. No.: US 2010/0221596 A1
(43) Pub. Date: Sep. 2, 2010

(54) SYSTEMS, METHODS OF MANUFACTURE AND USE INVOLVING LITHIUM AND/OR HYDROGEN FOR ENERGY-STORAGE APPLICATIONS

(76) Inventors: Robert A. Huggins, Stanford, CA (US); Colin D. Wessells, Eugene, OR (US); Yi Cui, Sunnyvale, CA (US)

Correspondence Address: CRAWFORD MAUNU PLLC, 1150 NORTHLAND DRIVE, SUITE 100, ST. PAUL, MN, 55120, US

(21) Appl. No.: 12/700,442

(22) Filed: Feb. 4, 2010

Related U.S. Application Data
(60) Provisional application No. 61/150,484, filed on Feb. 6, 2009.

(51) Int. Cl. H01M 6/42; H01M 4/58; H01M 4/82; H01M 6/00

(52) U.S. Cl. 429/149; 429/218.2; 29/623.1; 29/623.5

(57) ABSTRACT

Energy storage cells, batteries and associated methods and uses are implemented in a variety of manners. Consistent with one such implementation, a lithium ion and hydrogen ion battery cell includes a first electrode configured to store energy by interacting with lithium cations. A second electrode is configured to store energy by interacting with hydrogen cations. An aqueous electrolyte separates the first electrode from the second electrode and provides both the lithium cations and the hydrogen cations.

### RELATED DOCUMENTS

This patent document claims the benefit, under 35 U.S.C. §119(e), of U.S. Provisional Patent Application Ser. No. 61/150,484 filed on Feb. 6, 2009, and entitled “Systems, Methods Of Manufacture And Use Involving Lithium and/or Hydrogen For Energy-Storage Applications” this patent document, which includes each of the Appendices filed with the underlying provisional application, is fully incorporated herein by reference.

### BACKGROUND

Controlled storage of energy is of utmost import to numerous applications and for a variety of reasons. The storage and subsequent retrieval of energy generally involves a conversion in the form of the energy. A particular controlled storage involves storage of energy in chemical energy and retrieval of the stored chemical energy in the form of electrical energy. The devices for providing this transduction between energy forms are sometimes referred to as cells and more particularly galvanic or battery cells. Compared to many other energy storage mechanisms, the use of chemical species to store energy provides an attractive solution, both in terms of costs and energy stored per unit volume or weight.

For many applications, such as vehicle propulsion, an attractive battery technology involves lithium systems. They are often described by labels such as lithium-ion cells and lithium-polymer cells. They characteristically have electrodes in which the active materials can contain, and react with, lithium. Such cells operate by the transfer of lithium ions from a low voltage electrode to a higher voltage electrode, and the reverse, through a liquid electrolyte. The electrode reactions often involve the insertion and extraction of lithium ions from the crystal structures of the electrode materials. The electrolytes between the electrodes are typically liquid organic solvents containing lithium salts.

Such lithium-based cells can contain very large amounts of energy, and their safety is a major concern. This is evidenced by the fact that there have been a number of large cell recalls for safety reasons. For instance, there is a tendency for these cells to overheat, leading to what is known as the “thermal runaway” problem. The higher the temperature, the more rapidly this problem gets worse. Heat can also pass from one cell to adjacent cells, causing them to also have this problem. Other major concerns include the expense, size and weight associated with lithium batteries.

Aspects of the present disclosure relate to materials and designs that can provide safer, lower cost, and more attractive energy storage properties.

### SUMMARY

Various aspects of the present disclosure are directed to devices, methods and systems for energy storage cells and batteries in a manner that addresses challenges including those discussed above.

Aspects of the present disclosure relate to rechargeable lithium-based energy storage cells that use an aqueous electrolyte. Aspects include selection of cell parameters to provide stable and safe operation with favorable energy storage characteristics. Various implementations relate to selection of positive and negative electrodes to correspond to the aqueous electrolyte and in some instances to a lithium-hydrogen hybrid energy storage cell.

Consistent with one embodiment of the present disclosure, a lithium ion and hydrogen ion battery cell includes a first electrode configured to store energy by interacting with lithium cations. A second electrode is configured to store energy by interacting with hydrogen cations. An aqueous electrolyte separates the first electrode from the second electrode and provides both the lithium cations and the hydrogen cations.

Consistent with embodiments of the present disclosure, a hybrid energy storage cell includes a positive electrode configured to store energy by interacting with lithium cations. A negative electrode is configured to store energy by interacting with non-lithium cations. An aqueous electrolyte is configured to separate the positive electrode from the negative electrode and to provide both the lithium cations and the hydrogen cations.

Embodiments of the present disclosure relate to methods of manufacturing a hybrid energy storage cell. A structure is provided that includes an aqueous electrolyte that provides both lithium cations and hydrogen cations. A first electrode is provided that includes a first material designed to store energy by interacting with the lithium cations. A second electrode is provided that includes a second material to store energy by interacting with hydrogen cations and that is electrically separated from the first electrode by the aqueous electrolyte.

Aspects of the present disclosure teach a range of different materials and configurations for a rechargeable energy storage cell as well as methodology for selection of additional materials and configurations.

The above summary is not intended to describe each embodiment or every implementation of the present disclosure. The figures and detailed description that follow more particularly exemplify various embodiments.

### BRIEF DESCRIPTION OF THE DRAWINGS

The invention may be more completely understood in consideration of the following detailed description of various embodiments of the invention in connection with the accompanying drawings, in which:

FIG. 1A shows the basic components of one rechargeable energy storage cell, consistent with implementations of the present disclosure;

FIG. 1B shows the electrochemical window stability for water and lithium reaction potentials for several materials in a lithium ion battery, consistent with aspects of the present disclosure;

FIG. 2 illustrates locations of compositions on the Gibbs triangle, showing iso-concentration lines, consistent with aspects of the present disclosure;

FIG. 3 shows an example with a single intermediate phase, consistent with aspects of the present disclosure;

FIG. 4 shows a ternary phase stability diagram for the Li—Cu—Cl₂ system at 298 K, consistent with aspects of the present disclosure;

FIG. 5 shows the variation of the overall composition as Li reacts with CuCl, as indicated by the dotted line and as consistent with aspects of the present disclosure;

FIG. 6 depicts the variation of the overall composition as Li reacts with CuCl₂, as indicated by the dotted line and consistent with aspects of the present disclosure;

FIG. 7 depicts variation of the theoretical cell voltage with composition when lithium reacts with an electrode with an initial composition CuCl₂, consistent with aspects of the present disclosure;

FIG. 8 shows results of Coulometric titration experiments on compositions in the Li—Co—O system, consistent with aspects of the present disclosure;

FIG. 9 depicts the results of coulometric titration experiments on compositions in a Li—Fe—O system, consistent with aspects of the present disclosure;

FIG. 10 depicts the results of a set of Coulometric titration experiments involving the Li—Mn—O ternary system, consistent with aspects of the present disclosure;

FIG. 11 depicts a relation between the voltage versus lithium and the oxygen pressure for the various three-phase sub-triangles in the three lithium-transition metal systems, consistent with aspects of the present disclosure;

FIG. 12 depicts such an extrapolation of the data shown in FIG. 11 to ambient temperature and higher voltages, consistent with aspects of the present disclosure;

FIG. 13 depicts extrapolated values of oxygen pressure versus voltage at 25° C., consistent with aspects of the present disclosure;

FIG. 14 shows the results of cycling voltammetry of LiCoO2 electrodes at 0.1 mV/s in different LiNO₃, consistent with aspects of the present disclosure;

FIG. 15 depicts a scan, from the 25^{th} cycle and at a rate of 1 C, where the observed capacity was 105 mAh/g, consistent with aspects of the present disclosure

FIG. 16A depicts results of cycling, covering 90 cycles, consistent with aspects of the present disclosure; and

FIG. 16B depicts the influence of the current upon the capacity during cycling, consistent with aspects of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims.

### DETAILED DESCRIPTION

As many aspects of the example embodiments disclosed herein relate to and significantly build on previous developments in this field, the following discussion summarizes such previous developments to provide a solid understanding of the foundation and underlying teachings from which implementation details and modifications might be drawn. It is in this context that the following discussion is provided and with the teachings in these references incorporated herein by reference. While the present invention is not necessarily limited to such applications, various aspects of the invention may be appreciated through a discussion of various examples using this context.

This disclosure relates to electrochemical cells, battery-type devices and the like. Embodiments of the present invention involve approaches that may lead to widely-used commercial batteries that are significantly safer than those that are currently available. In addition, these approaches allow for the use of new families of materials that can be considerably lighter weight and lower cost than those that are currently used.

Aspects of the present disclosure are believed to be useful in addressing various problems and concerns relating to energy-storage devices, their manufacture and use. Specific applications of the present invention are discussed above, in the description below and throughout the references cited herein including, for example, the recently-published book, R. A. Huggins, Advanced Batteries: Materials Science Aspects, Springer (2009), which is fully incorporated herein by reference.

For example, specific reference may be made to Ch. 9 and Ch. 10 of R. A. Huggins, Advanced Batteries Materials Science Aspects, Springer (2009), respectively, for background discussion and applications involving positive electrodes and involving metal hydrides. The relevant portions of other areas of this recently-published book and the other cited references should be apparent.

The embodiments of the present disclosure lend themselves to an enormous number of applications. For instance, the battery cells discussed herein can be particularly useful for consumer products that have relatively high-power consumption. These can include handheld processing devices, communications devices, gaming devices and a variety of other devices. Battery cells can be specially designed for particular devices or arranged according to industry standards. Particular implementations of such battery cells offer safe operation with high specific capacity that can be sustained over numerous recharge cycles.

Other applications include, but are not limited to, high-power applications that use large/many cells to provide large amounts of power. For instance, electric motors can often require significant power. Thus, electric/hybrid vehicles, handheld tools and various other devices can benefit from aspects of the present disclosure.

Temporary power storage is often required for renewable sources of energy due to their intermittent generating capabilities and/or lack of adjustable power generation (e.g., solar or wind power). Other applications can also benefit from off-peak storage of excess energy. Thus, aspects of the present disclosure can be particularly useful for such temporary storage.

Accordingly, the various teachings of the present disclosure can be used in a variety of applications, only some of which are expressly mentioned herein. Moreover, variations and additions from the express teachings of the present disclosure can be implemented for different applications.

Embodiments of the present disclosure teach implementations of lithium-based energy storage cells that can be implemented using an aqueous electrolyte. By careful selection of energy storage cell parameters and materials, an aqueous electrolyte can be safely used despite the conventional wisdom suggesting that lithium and water present an unstable combination. The electrodes of the energy cell are also carefully selected so as to maintain the electrochemical potentials of the electrodes within the range of stability of the aqueous electrolyte.

Specific embodiments of the present disclosure relate to lithium-hydrogen hybrid energy storage cells. The cells include both a lithium-reacting electrode and a hydrogen-reacting electrode. The electrodes can be separated by an aqueous electrolyte.

The present disclosure discusses a variety of different energy cell configurations and materials. In this context, the present disclosure also teaches methodology for finding additional configurations and materials. Accordingly, the specific examples provided herein are not meant to be limiting and provide a foundation from which additional embodiments can be better understood. It is in this context that much of the following discussion is framed.

Active materials in positive electrodes of lithium battery cells can include lithium-transition metal oxides, such as LiₓCoO₂ or LiₓMn₂O₄ or materials with poly-anions, such as LiₓFePO₄. The negative electrode reactant is often a variant of graphite or a related carbon material. The amount of lithium that can react with these materials determines their respective capacities. The combination of the voltage and the capacity determines the amount of energy that they can store.

Overheating, which can cause serious problems, has sometimes been found to occur in lithium cells. This overheating problem can increase in severity as the positive electrode potential increases. It is believed that this heating is primarily due to the evolution of oxygen from the positive electrode materials when they are highly charged. This oxygen then reacts with the adjacent organic electrolyte solvent, which is highly reducing.

Aspects of the present disclosure recognize that lithium intercalation for high potential lithium ion battery electrodes can occur in water, as well as organic solvent electrolytes. Aspects of the present disclosure are directed toward implementing a battery cell that has a reaction potential range that lies within the electrochemical stability window of the aqueous electrolyte. For instance, the value of the pH can be selected to control the potential range within which water is stable.

The potential of the standard hydrogen electrode (SHE) is 3.045 V above that of pure lithium. However, the reversible hydrogen potential (RHE), which is the theoretical value below which hydrogen gas should evolve from water, decreases from the SHE at a rate of 0.059 mV per pH unit. The theoretical upper stability limit of water, above which oxygen should evolve, is 1.23 V above the RHE value, and therefore also pH dependent. Aspects of the present disclosure, however, use the realization that water decomposition seldom occurs at its theoretical limits Over-potentials occur, with oxygen evolution from water not occurring at measurable rates until excess potentials of the order of 350 to 400 mV are reached. On the other hand, the potentials of lithium battery electrode materials are referenced to the lithium potential, which is independent of pH. Thus, the lithium battery electrode materials are also independent of pH.

In principle, the use of materials that are outside the stability range of water will tend to cause it to decompose. Positive electrode reactants that contain lithium and have potentials above the limit of water stability will react with water, releasing oxygen gas, forming LiOH, with the concurrent evolution of hydrogen gas. This will tend to increase the pH of the water. It will not occur if their potentials are within the stability range of water.

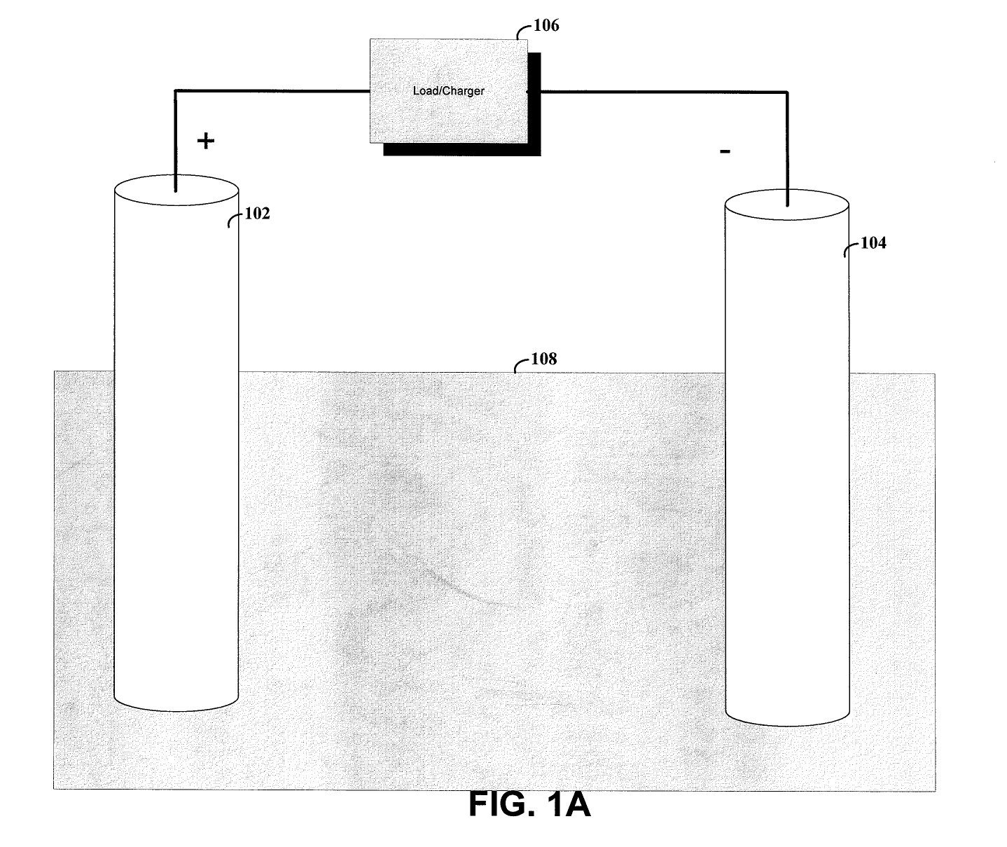

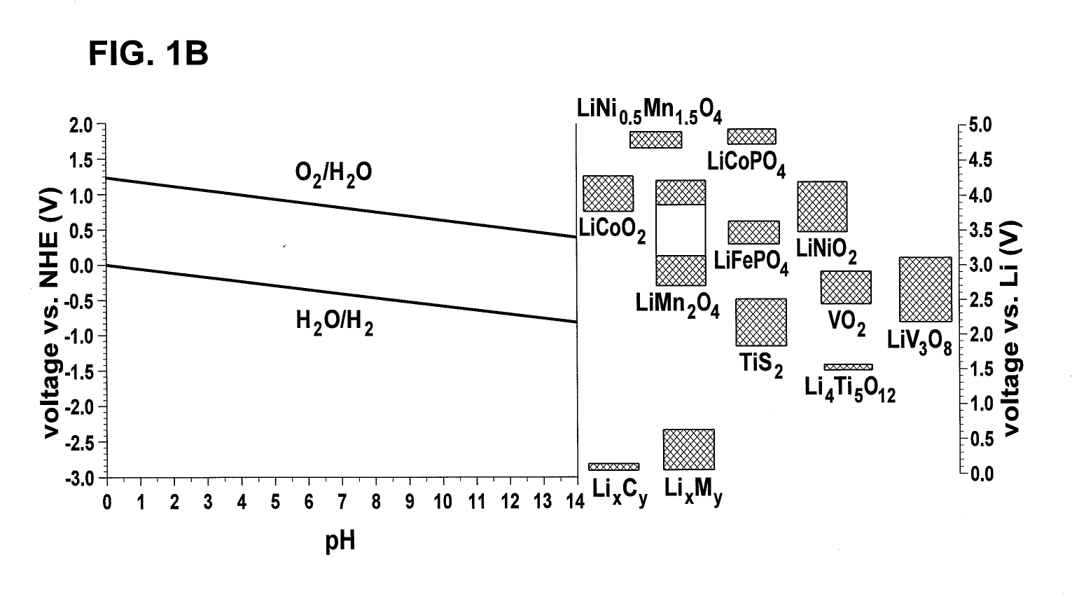

The various energy storage cells can be used for a variety of different applications. FIG. 1A shows the basic components of one rechargeable energy storage cell, consistent with implementations of the present disclosure. Positive and negative electrodes 102 and 104, respectively, are in contact with electrolyte 108. Electrons are provided to and from the electrodes from load/charger 106. This basic configuration underlies a number of more complicated energy cell configurations, including the use of numerous cells to form a battery.

The particulars of the electrode shapes, sizes and other aspects can be determined according to the specific application. Applications for the rechargeable energy cell are numerous and can include, but are not limited to, vehicles, large-scale power storage, handheld processing devices, backup power supplies and a variety of other applications.

In a particular implementation, the electrodes 102 and 104 are designed to interact with specific and different ionic materials. For instance, negative electrode 104 can be designed to react with hydrogen cations, whereas positive electrode 102 can be designed to react with lithium ions. Moreover, various aspects of the present disclosure explain that separator 108 can be implemented as an aqueous electrolyte, even with the lithium ions.

For instance, the energy storage cell can be designed such that the aqueous electrolyte does not break down or otherwise release hydrogen or oxygen across a desired stable voltage range. Careful selection of the electrodes 102 and 104 allows for the energy storage cell to operate entirely within the stable range of the aqueous electrolyte. Surprisingly, this results in a stable and safe energy cell with a variety of obtainable and advantageous properties.

The electrodes 102 and 104 can be designed as primarily from materials that store energy by interacting with the appropriate ions. Specific examples of the materials as well as details for selection and design of such materials are provided herein. If desired, the electrodes can be formed by coating an electrically conductive material with these ion-storing materials. The electrically conductive material can provide structural integrity and/or conductive properties. Various structures, configurations and materials can be designed according to the specific application.

The careful selection of energy cell materials and configurations is discussed in more detail within the present disclosure. In this context, FIG. 1B shows both the theoretical water stability range, and its pH dependence, generally known as Pourbaix diagrams, and the operating potentials of a number of lithium battery electrode materials, consistent with implementations of the present disclosure. Previous investigations into the possibility of the use of lithium reactant electrodes in aqueous electrolytes suggested that the issues, such as the lower potential range of water puts a limit upon the possible cell voltage. Aspects of the present disclosure recognize that such an approach can be particularly useful for providing increased safety and lower cost relative to organic solvent electrolyte lithium batteries. Other features include high rate operation, better reversibility and extended cycle life.

For instance, water is much cheaper than most organic solvents. Inexpensive water-soluble salts are available, as are separators. In addition, the ionic conductivity of aqueous electrolytes is often significantly greater than that of the organic electrolytes, allowing higher rates and lower voltage drops due to electrolyte impedance.

Much of the early work on lithium reactants in water electrolytes involved the use of LiMn₂O₄ as the positive electrode, and the combination of LiMn₂O₄ and VO₂ produced very attractive results. Subsequently, there have been investigations in which LiCoO₂ was investigated as a potential positive electrode reactant in aqueous electrolyte systems.

FIG. 1B shows the electrochemical window stability for water and lithium reaction potentials for several materials in lithium ion batteries, consistent with aspects of the present disclosure. As can be seen in FIG. 1B, the operating potential range LiCoO₂ in organic electrolyte cells is not far from that of LiMn₂O₄. It has a relatively flat potential profile, high charge/discharge efficiency, a rather good cycle life, and attractive specific power properties in organic solvent electrolytes, and is used in a number of commercial batteries. The properties of LiCoO₂ in aqueous electrolytes have consistently been taught to be relatively unfavorable. For example, the initial discharge capacity in a saturated LiNO₃ electrolyte has been reported to be only 35 mAh/g at a 1 C rate. This rate was also reported as falling significantly upon cycling, becoming less than 20 mAh/g after 100 cycles. Other reports suggest an initial value of 60 mAh/g at a current density of 0.2 mA/cm², which then fell to about 40 mA/cm² after 12 cycles. These are significantly lower than what is generally found in organic solvent electrolyte cells.

Surprisingly, aspects of the present disclosure show that LiCoO₂ can have very attractive properties in an aqueous electrolyte. Water is stable over a much wider potential range than expected from its thermodynamic properties in aqueous solutions of LiNO₃. Cyclic voltammetric experiments with a nickel electrode showed a span of about 2.4 V, and this has been verified using a stainless steel electrode. Surprisingly, stability has been discovered up to about 1.6 V above the SHE in 1 and 5 molar solutions of LiNO₃, where the pH is 7. The theoretical limit at that pH is only 0.817 V. Thus, positive electrodes with potentials as high as 4.6 V vs. Li should be stable in this aqueous solution. Accordingly, such electrolytes can be useful as an inexpensive and simple tool for high potential lithium battery reactants.

Aspects of the present disclosure recognize that the possibility of the formation of elemental lithium on the negative electrode side of graphite-containing cells can result in a safety problem, and can become significant for high current cells. One approach to reduce this negative electrode safety problem is to replace the low potential carbon reactant with another material, such as LiₓTi₅O₁₂, that reacts at a higher, and safer, potential. This however, has the disadvantage that the (e.g., about 1.55 V) higher potential reduces the output potential of the cell, and thus its energy.

According to certain embodiments of the present invention, energy-storage devices are constructed and used based on improved materials (relative to those currently used) that can store increased amounts of energy per unit weight (“the specific energy”). The prevailing approach is to look for alternative lithium transition metal oxides, preferably with higher voltages. However, as mentioned above, this approach is not always ideal as such approaches have been known to increase the potential safety problem. Also mentioned above is the issue resulting from efforts to replace the carbon negative electrode with a lithium-transition metal oxide such as LiₓTi₅O₁₂. While this may reduce the high power safety problem, this effort can cause a reduction in the specific energy.

Certain embodiments of the present invention are directed to energy storage involving aqueous electrolytes with extended stability ranges. The electrochemical stability range of pure water is only 1.23 V. This limits the voltage of any battery in which it is used as the electrolyte. However, it has been found that this voltage limit can be greatly increased by adding species to the water. One particularly useful, simple, and inexpensive example is to use solutions of LiNO₃ in the water. Experiments have shown that its stability range can extend from 2.34 V vs lithium to 5.09 V vs lithium, a range of 2.77 V. To be useful, both electrodes should have potentials within that range.

According to other embodiments, the present disclosure is directed to power storage devices constructed and configured to provide potential improvements over lithium batteries that can both reduce the safety problem and increase the specific energy.

In connection with the present disclosure, surprising results have been discovered. For example, it has recently been shown that it is possible to use LiₓCoO₂, a material that is commonly used as a high potential positive electrode in organic electrolyte cells, in these modified aqueous electrolytes. Replacing the organic solvent electrolyte with one based on water, such as a LiNO₃-water solution, is particularly useful for mitigating, or even completely removing, the high potential safety problem without limiting the potential of the positive electrode.

Other aspects of the present disclosure relate to electrodes with both suitable potentials and attractive capacities. Using an electrode with a significantly lower weight per unit capacity can be particularly useful in applications that benefit from increases in the specific energy of the electrochemical cell. To this end, various embodiments are described in the following paragraphs as alternate approaches.

In certain example embodiments, electrode materials have been identified that react with hydrogen instead of with lithium. A number of materials are known that react with hydrogen in aqueous-electrolyte electrochemical cells. Some of these are currently used in the common commercial metal hydride/“nickel” batteries. The potentials of the negative electrode materials in these metal hydride batteries can fall within the stability range of the LiNO₃-water electrolyte.

Certain embodiments of the present disclosure are directed to use of lithium—hydrogen hybrid batteries. Since both lithium-reacting and hydrogen-reacting materials can be stable within the stability window of the LiNO₃-water electrolyte, which contains both lithium and hydrogen ions, it is possible to use low potential hydrogen-reacting negative electrode reactants in combination with the high potential lithium-reacting positive electrode materials. Consistent with the present invention, various embodiments are based on this lithium-hydrogen hybrid battery energy-storage approach.

Some of the materials that are useful in metal hydride batteries have lower weights per unit capacity than those found in any of the negative electrode materials currently used in lithium batteries and thus can be particularly useful. This can be seen from the data in Table 1 below, in which the weights and relative specific capacities of a number of lithium-reacting and hydrogen-reacting materials are shown.

TABLE 1
Data on the specific capacities of analogous lithium and
hydrogen host electrode materials.

| | Host | No. of inserted | | Relative |
|---|---|---|---|---|
| | weight/ | atoms/ | Weight of host per | Specific |
| Material | mol | mol of host | inserted atom, gm | Capacity |
| LiCoO₂ | 90.93 | 0.5 Li | 181.86 | 1 |
| LiFePO₄ | 150.82 | 1 Li | 150.82 | 1.21 |
| LiC6 | 72 | 1 Li | 72 | 2.53 |
| TiNi | 106.6 | 1 H | 106.6 | 1.71 |
| Ti₂Ni | 154.45 | 2 H | 77.23 | 2.35 |
| LaNi₅ | 432.41 | 6 H | 72.07 | 2.52 |
| FeTi | 103.73 | 2 H | 51.87 | 3.51 |
| Mg₂Ni | 107.3 | 4 H | 26.83 | 6.78 |
| β-Titanium | 47.88 | 2 H | 23.94 | 7.60 |
| β-Titanium | 47.88 | 1 H | 47.88 | 3.80 |

Such a lithium-hydrogen hybrid approach can be particularly useful for avoiding the safety problem in high voltage lithium batteries that contain organic electrolytes. In addition, such approaches can provide significantly higher specific energy, e.g., by using metal hydride materials. Accordingly, electrodes can be made from a variety of materials including HₓTiNi, HₓTi₂Ni, HxLaNi₅, HxFeTi, HxMg₂Ni, β-Ti, and alloys thereof.

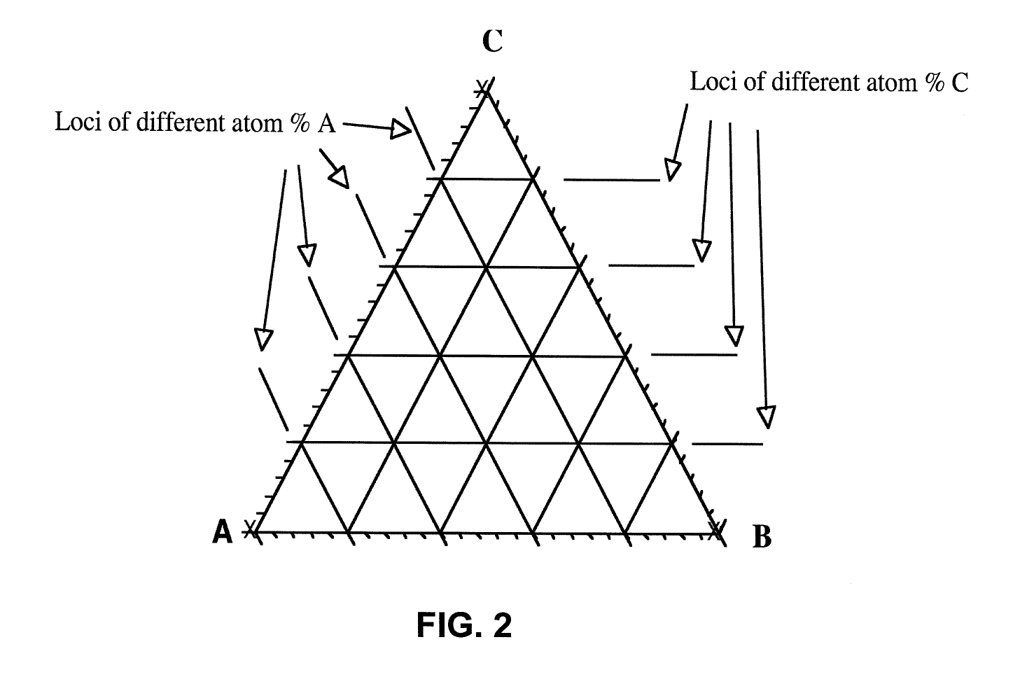

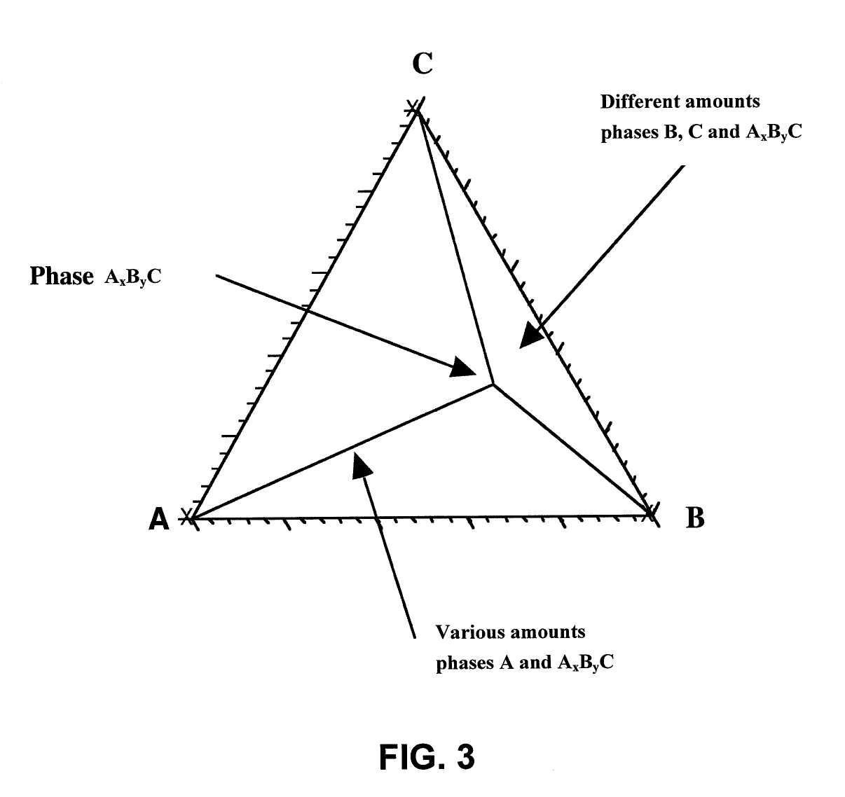

These and other material combinations can be evaluated using the isothermal Gibbs triangle. For instance, an analysis of ternary lithium-transition metal oxide materials is possible. For such materials there are three different types of atoms present, so they can be treated thermodynamically as three-component systems. FIG. 2 illustrates locations of compositions on the Gibbs triangle, showing iso-concentration lines, consistent with aspects of the present disclosure. If the phases present are represented by single points, rather than indicating their actual compositional ranges, such diagrams can be called ternary phase stability diagrams. FIG. 3 shows an example with a single intermediate phase, consistent with aspects of the present disclosure. It is seen that the total triangle is divided into a number of sub-triangles.

If the stable phases in such a ternary system are known, as well as the values of their respective Gibbs free energy of formation, a number of important parameters can be calculated. In the cases in which one of the components is oxygen and another is lithium, these include the voltages versus all three components and the equilibrium oxygen pressure of all compositions within each sub-triangle. From these data, the capacities of oxide electrodes of any initial composition in a lithium system can also be determined.

One can also do the reverse, and measure voltages at selected compositions in a given sub-triangle in order to determine the related Gibbs free energy of formation values for phases at one of the corners if values of the others are already known. This information can then be used to evaluate data for compositions in adjacent sub-triangles.

The relation between the oxygen pressure and the voltage versus lithium in ternary lithium metal oxide systems is especially interesting. To help explain the relevant relationships, a simple example will first be briefly discussed.

Regarding a Li—Cu—Cl ternary system, an analysis can be performed to answer the question of the possibility of lithium/copper chloride cells at ambient temperature. One example for consideration is a non-aqueous solvent electrolyte, such as propylene carbonate, containing a lithium salt such as LiClO₄. Since lithium will be used as the negative electrode, it is important to avoid water and oxygen, so that such experiments must be conducted, or at least assembled, in a good glove box. The salt should have a relatively high solubility and conductivity in the non-aqueous solvent.

The Gibbs free energy of formation values for the simple binary chlorides in this ternary system are shown in Table 2.

TABLE 2
Known Phases in the Li—Cu—Cl System and Their Gibbs
Free energies of Formation.

| | ΔGr° at 298 K |
|---|---|
| Phase | (kJ/mol) |
| LiCl | −384.0 |
| CuCl | −138.7 |
| CuCl₂ | −173.8 |

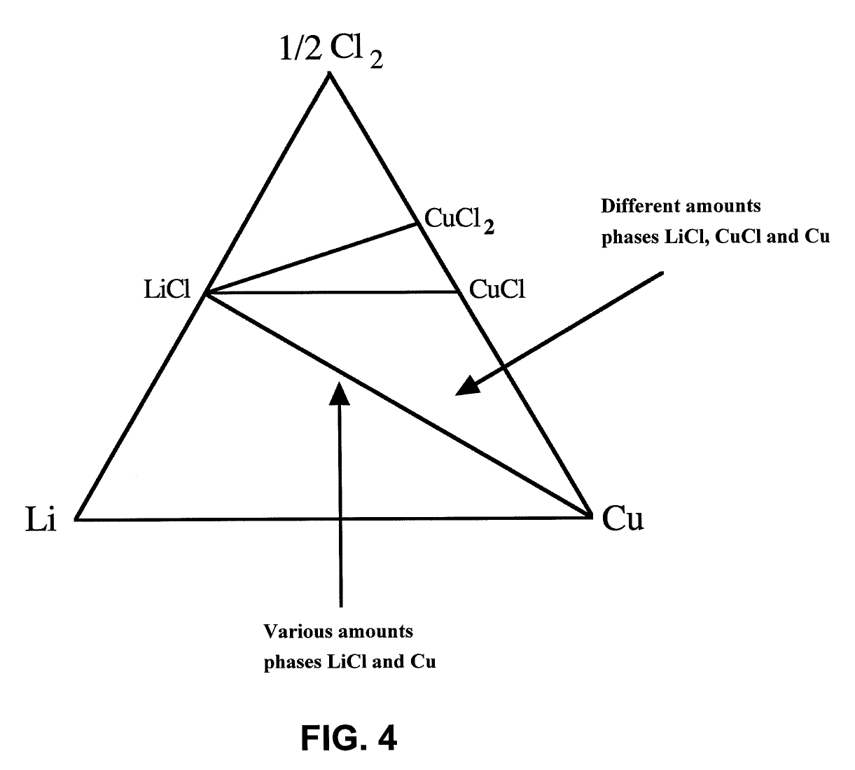

FIG. 4 shows a ternary phase stability diagram for the Li—Cu—Cl₂ system at 298 K, consistent with aspects of the present disclosure. If it can be assumed that there are no intermediate ternary phases in this system, the Gibbs triangle will appear as shown in FIG. 4.

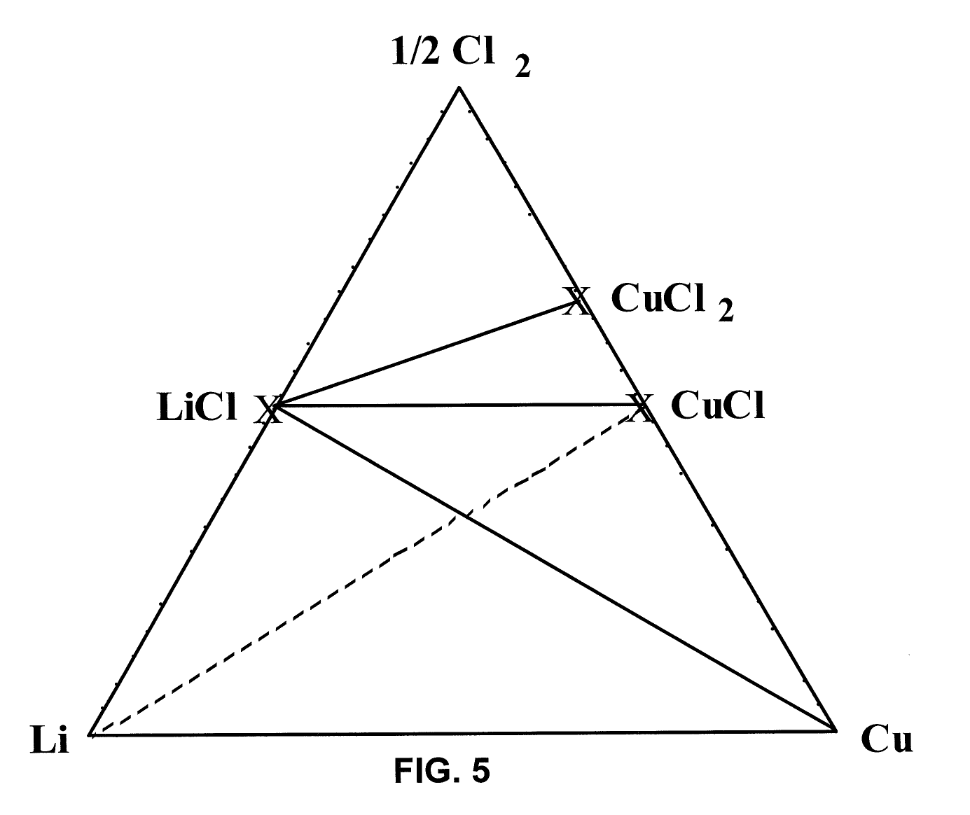

FIG. 5 shows the variation of the overall composition as Li reacts with CuCl, as indicated by the dotted line and as consistent with aspects of the present disclosure. If lithium were to react with an electrode composed of CuCl the overall composition would follow the path indicated by the dotted line in FIG. 5. It first traverses the sub-triangle that has LiCl, CuCl and Cu at its corners, and the relative amounts of these phases changes as the overall composition varies. The reaction that occurs as the composition moves through this triangle is

Li+CuCl=LiCl+Cu

and, using the data in Table 2, the standard Gibbs free energy of this reaction is found to be −245.3 kJ. From this value and the relation

E=−ΔG_{f}⁰/zF

it is found that the voltage between all compositions within this triangle and pure lithium is 2.54 V.

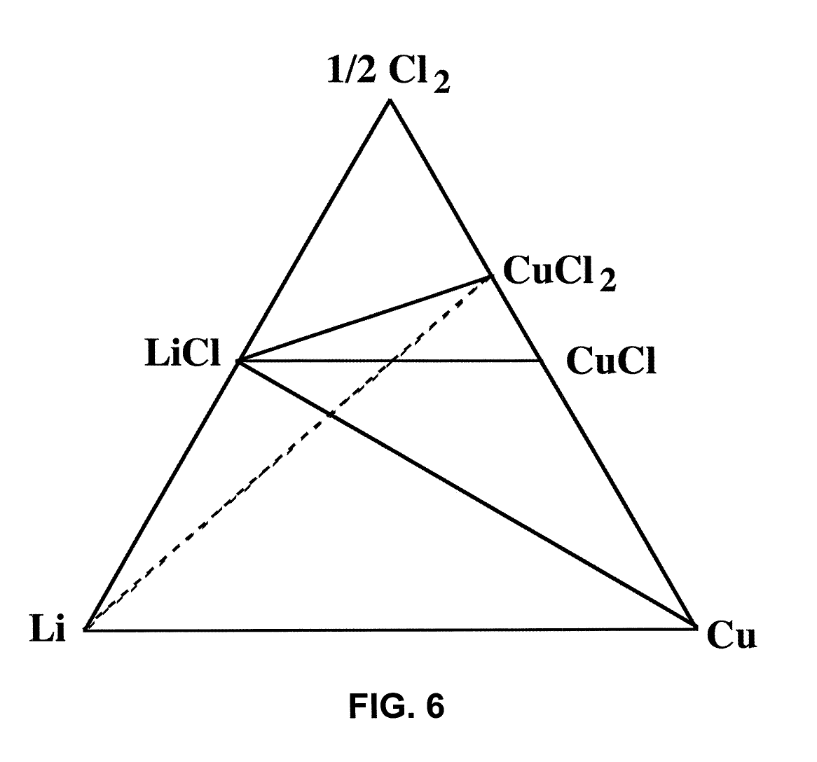

FIG. 6 depicts the variation of the overall composition as Li reacts with CuCl₂, as indicated by the dotted line and consistent with aspects of the present disclosure. If, instead of CuCl, an electrode is initially composed of CuCl₂, the overall composition will follow the path indicated by the dotted line in FIG. 6. In this case it can be seen that the overall composition passes through two sub-triangles in succession. The reaction that occurs as the composition moves through the first triangle is

Li+CuCl₂=CuCl+LiCl

and from the data in Table 1 the standard Gibbs free energy of this reaction is found to be −348.9 kJ. It is found that the voltage between all compositions within this triangle and pure lithium is 3.615 V.

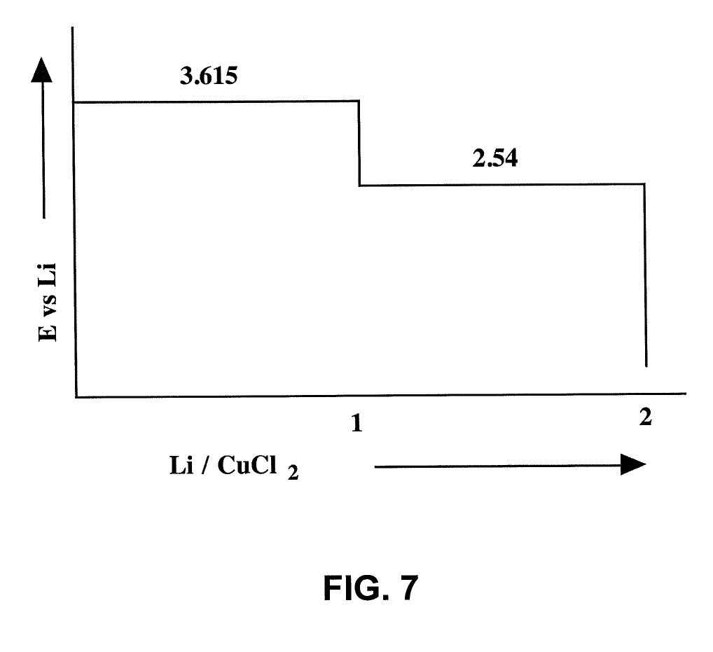

From these data and the composition changes involved in the two reactions, it is possible to determine the theoretical relation between the potential and the composition in this system. FIG. 7 depicts variation of the theoretical cell voltage with composition when lithium reacts with an electrode with an initial composition CuCl₂, consistent with aspects of the present disclosure. In any practical cell running at a finite current, however, there would inevitably be some kinetic losses.

Experiments of this type were performed on a number of materials in the Li—Co—O, Li—Mn—O and Li—Fe—O ternary systems using molten salt electrolytes at 400° C. Because of the requirement to maintain oxygen and nitrogen concentrations at very low levels, the experiments were conducted in a glove box.

The oxygen levels in the glove box and the thermodynamics of the formation of Li₂O put a limit on the range of lithium activity that could be investigated. This meant that potentials above 1.82 V versus pure lithium were not explored.

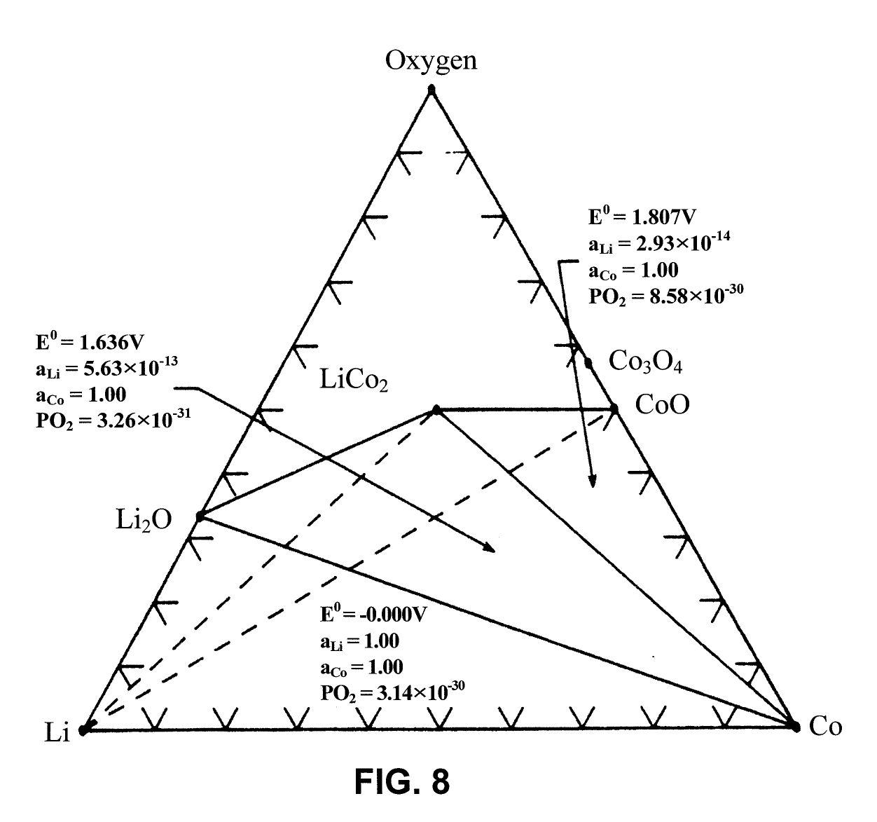

A Coulometric titration method was used, in which the composition was varied incrementally, and the equilibrium voltage measured after each step. For background information on such a technique reference can be made to R. A. Huggins, Advanced Batteries: Materials Science Aspects, Springer (2009), which is fully incorporated herein by reference. FIG. 8 shows results of Coulometric titration experiments on compositions in the Li—Co—O system, consistent with aspects of the present disclosure. Two initial compositions were used in these experiments, CoO and LiCoO₂. It can be seen that the composition lines went through two sub-triangles, each with a characteristic potential.

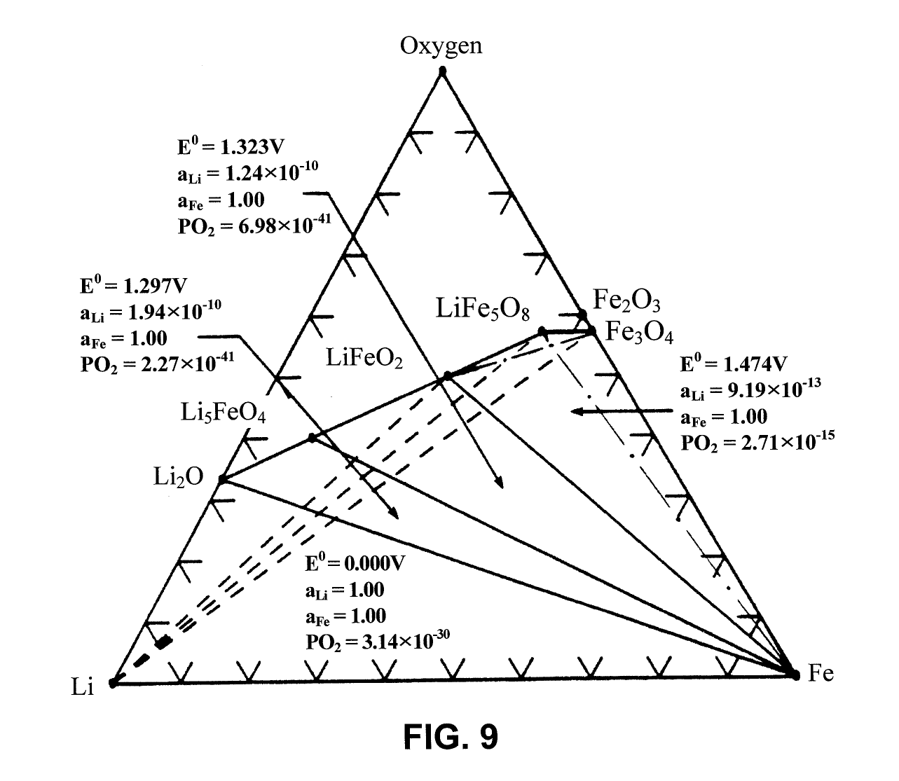

FIG. 9 depicts the results of coulometric titration experiments on compositions in a Li—Fe—O system, consistent with aspects of the present disclosure. A total of four different constant potential plateaus were found.

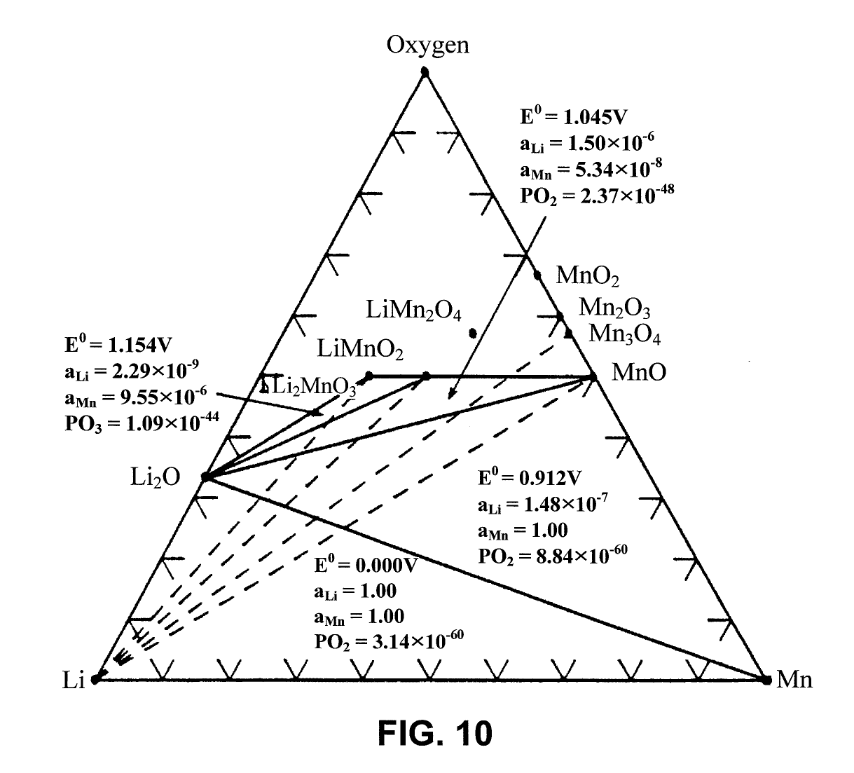

FIG. 10 depicts the results of a set of Coulometric titration experiments involving the Li—Mn—O ternary system, consistent with aspects of the present disclosure. Four initial compositions, MnO, Mn₃O₄, LiMnO₂ and Li₂MnO₃, were investigated, and three constant potentials plateaus were found.

The equilibrium voltage versus lithium, the oxygen pressure, and also the respective activities for all compositions in each of the sub-triangles are shown in each of these figures.

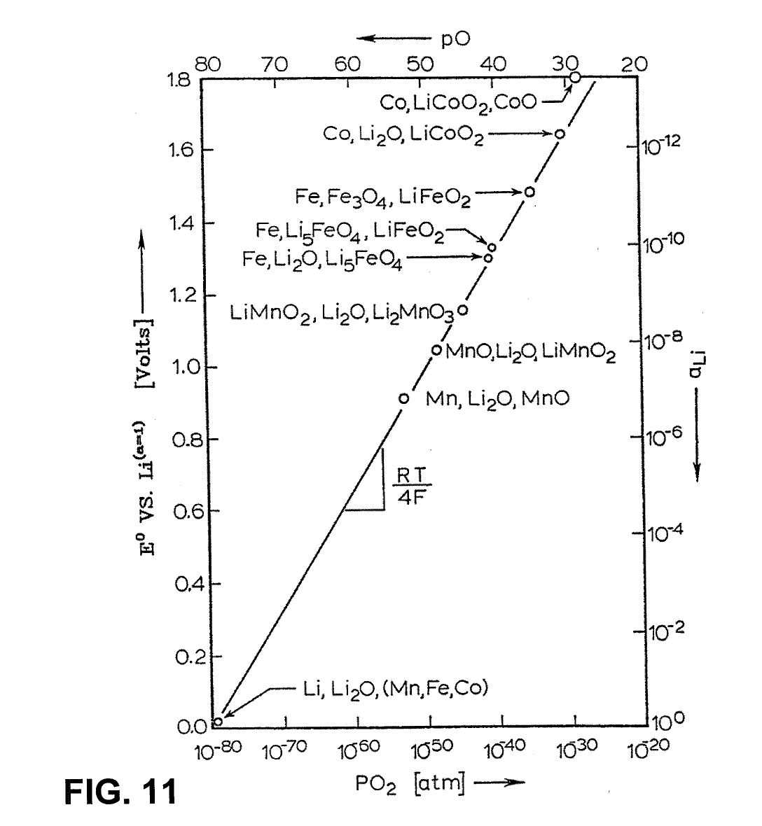

FIG. 11 depicts a relation between the voltage versus lithium and the oxygen pressure for the various three-phase sub-triangles in the three lithium-transition metal systems, consistent with aspects of the present disclosure. An especially interesting result was the observation of a linear relation between the voltage versus lithium and the oxygen pressure. It is seen that the data involving ten different phases in these systems all fit this relation quite well. These materials have a variety of different compositions and crystal structures.

The equation for this line is

E=1.45×10⁻² ln p(O₂)+2.65V

Evaluation for 1 atm of oxygen at 400° C. gives 2.65 V. This can be converted to ambient temperature, where it is 2.91 V, which is the equilibrium decomposition voltage of Li₂O.

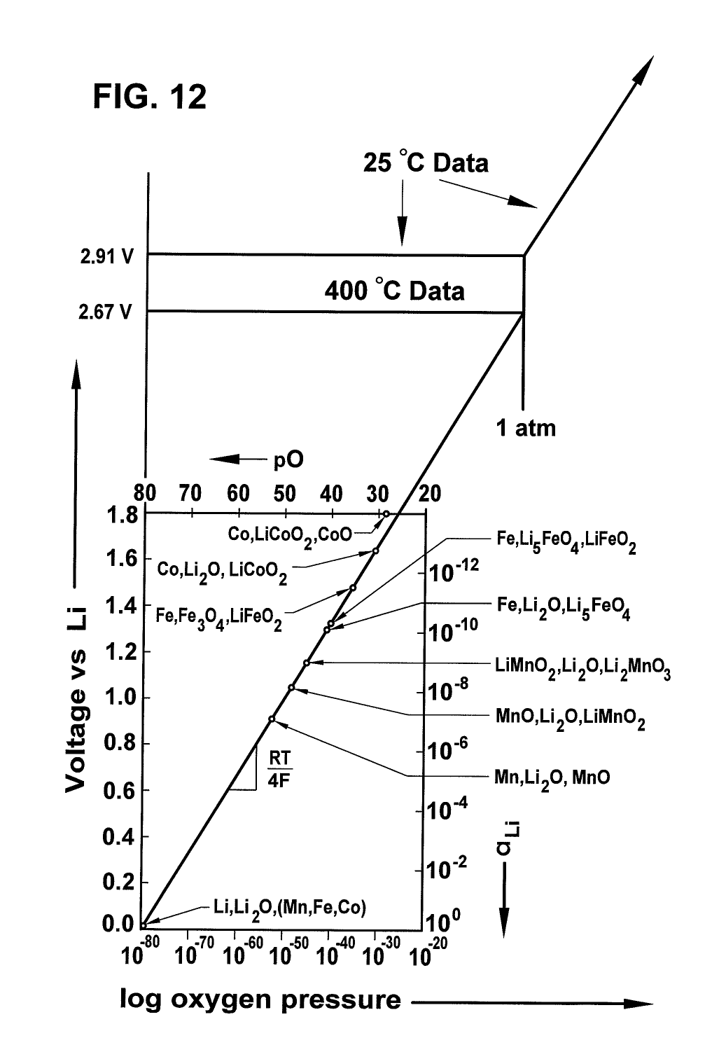

These measurements were limited to only 1.82 V for experimental reasons. However, these data can be readily extrapolated to lower temperatures and higher voltages. FIG. 12 depicts such an extrapolation of the data shown in FIG. 11 to ambient temperature and higher voltages, consistent with aspects of the present disclosure.

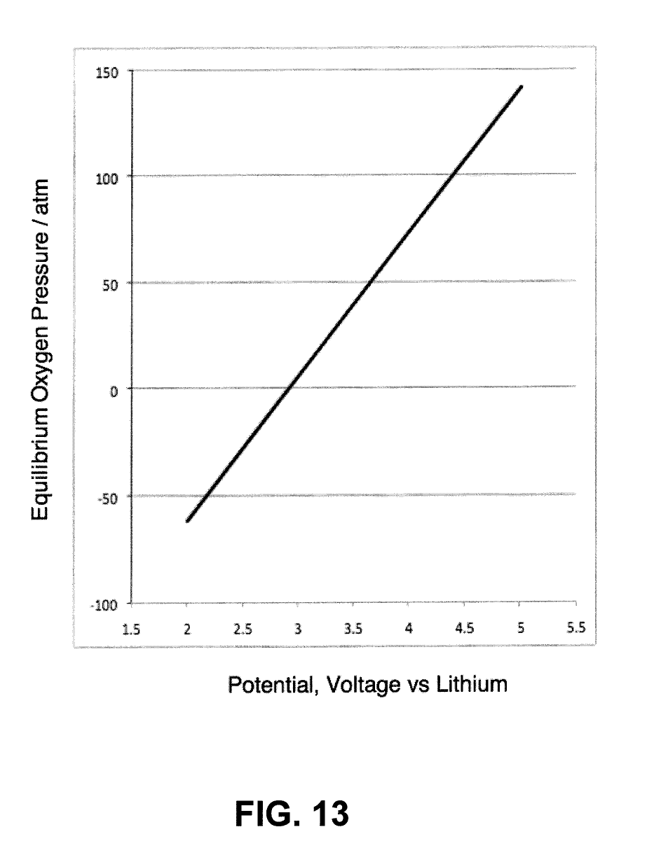

FIG. 13 depicts extrapolated values of oxygen pressure versus voltage at 25° C., consistent with aspects of the present disclosure. It can be seen that the equilibrium oxygen pressure becomes very large when the electrode potential gets into the range of a number of materials that are currently being explored as high voltage cathodes in lithium battery systems.

The equilibrium oxygen pressure in the voltage range for high voltage cathode materials in lithium battery systems can become very large. Within the range of many of the ternary lithium-transition metal oxides discussed in this disclosure, this relationship is independent of the chemical composition and also the crystal structure.

In a number of cases, the evolution of oxygen from such materials has been experimentally observed. This can be particularly pertinent when considering the reaction of oxygen with the highly reducing organic solvents used in current lithium batteries is recognized as a cause of the dangerous thermal runaway that has been observed in a number of cases. It can also be particularly pertinent for larger and higher power cells.

Consistent with various embodiments of the present disclosure, an experimental battery cell was implemented using commercial LiCoO₂ powder obtained from Aldrich (99.8% purity). No further treatment was performed on the powder. Electrodes were prepared by mixing LiCoO₂ powders with carbon black and an organic binder (PVDF), in a weight ratio of 80:10:10 in NMP (n-methylpyrrolidone), also from Aldrich. After stirring, the mixture was deposited on stainless steel foil (type 304) by dipping, and then dried at 100° C. for 1 h. The electrodes area was about 1.0 cm², and the weight of active material was typically in the range 3-5 mg for each sample.

Electrochemical characterization was performed by the use of both cyclic voltammetry (CV) and galvanostatic cycling with potential limitation (GCPL) using Autolab PGSTAT100 and Biologic VMP3 instruments, respectively. All the measurements in LiNO₃ (from 0.1 to 5 M) aqueous electrolytes were made in a beaker cell using a double junction Ag/AgCl (3 M KCl) as references electrode. For convenience, all potentials will be reported vs. the Standard Hydrogen Electrode (SHE). The counter electrode (CE) was a slightly large Li_{0.5}Mn₂O₄ layer in the same electrolyte compartment. This was prepared by delithiation of LiMn₂O₄ in 5 M LiNO₃. X-ray diffraction measurements were performed on the electrode layers using a PANalytical X′Pert diffractometer with Cu Kα-radiation. The cell parameters were refined in the rhombohedral system using the R-3m space group.

The electrochemical stability window of aqueous electrolytes containing LiNO₃ showed a lack of decomposition up to about 1.6 V versus the SHE. To understand the electrochemical behavior of LiCoO₂ in the lithium nitrate aqueous solutions cyclic voltammetry experiments were performed from 0.4 V to 1.1 V versus the SHE using aqueous electrolytes containing different concentrations of LiNO₃, 0.1, 1.0 and 5.0 molar. This involved the use of a platinum counter electrode.

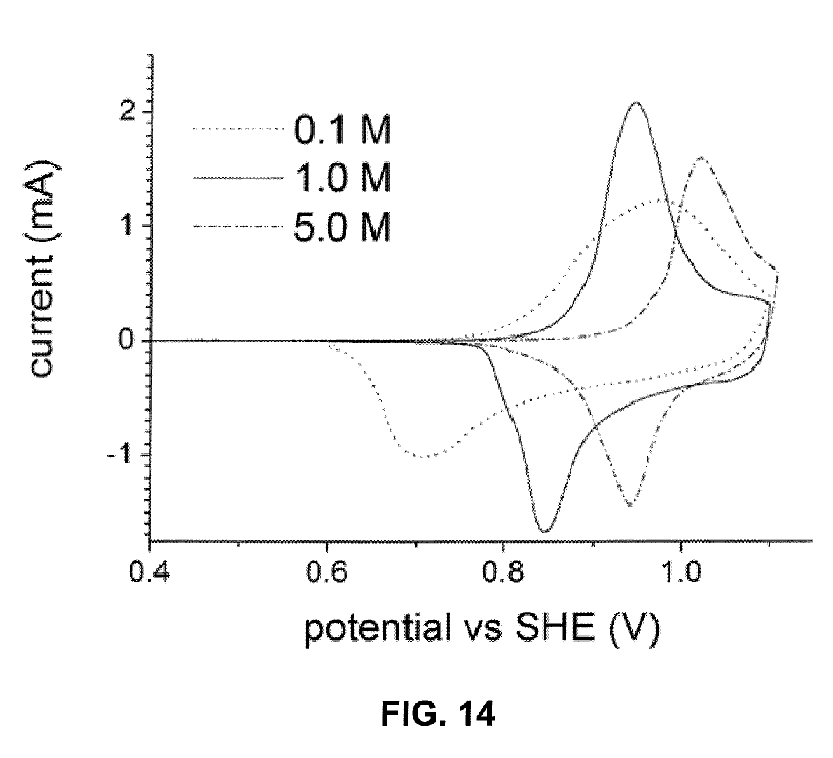

FIG. 14 shows the results of cycling voltammetry of LiCoO₂ electrodes at 0.1 mV/s in different LiNO₃, consistent with aspects of the present disclosure. The scan rate was rather low, 0.1 mV/s. In all cases, an electrochemical process was clearly observed, with current values several orders of magnitude higher than were found in the same potential range in absence of active material. Especially at the higher concentrations, the current peaks were quite sharp, and the positions of the cathodic and anodic peak potentials were quite close. This indicated fast kinetics.

The potentials were consistent with the insertion and extraction of lithium in LiCoO₂ in organic solvent electrolytes. X-ray diffraction experiments were also performed upon samples below and above the current peak potentials when going in the positive direction, as well as after the negative current peak as the potential had returned to its original value. These results suggest that the lattice parameter c had changed (from 15.3 to 15.8 Å) as the result of the positive current, and had returned to its original value (15.3 Å) after the reverse current peak. The lattice parameter c changes were consistent with what is observed when lithium is removed, and then re-inserted into LiCoO₂ using organic solvent electrolytes.

Galvanostatic cycling experiments were undertaken to evaluate the behavior of LiCoO₂ in an aqueous electrolyte containing 5 M LiNO₃. A flooded three-electrode electrochemical cell was used for this purpose. It included the LiCoO₂ working electrode, an Ag/AgCl reference electrode, and a large counter electrode of LiₓMn₂O₄. It is believed that the use of this counter electrode, with a mass some 20 times that of the working electrode, and an initial composition about Li_{0.5}Mn₂O₄, rather than an inert material, allows the cell to cycle reversibly, whereas the use of some other possible counter electrodes, such as stainless steel, nickel mesh, or platinum foil, that have been used by others for experiments in water are not fully reversible and can lead to a change in the composition of the electrolyte.

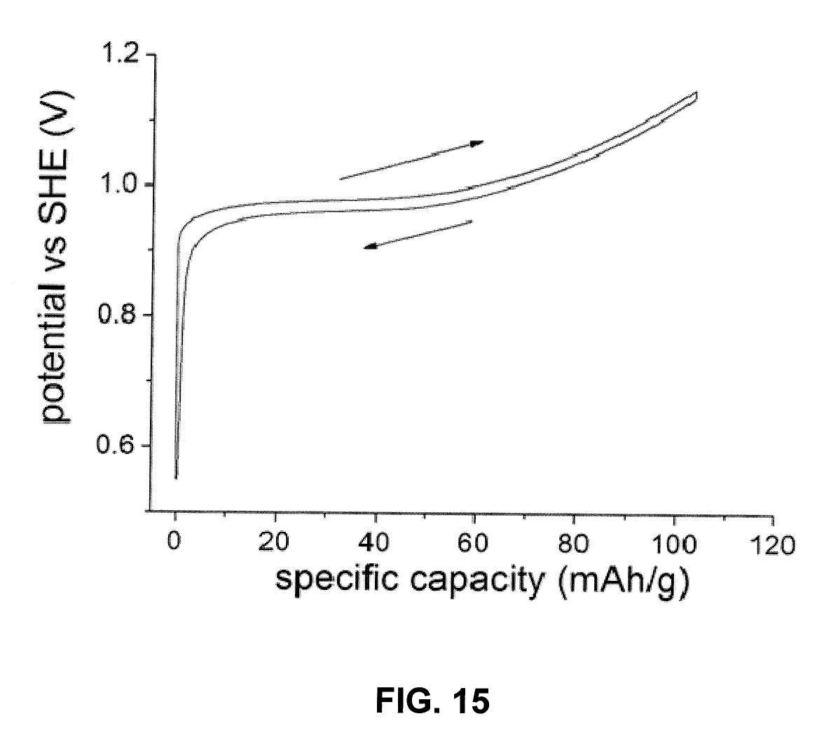

The potential range of these galvanostatic experiments was limited to 0.55 to 1.15 V above the SHE. This corresponds to the range in which the lithium concentration cycles from x equals 1.0 to 0.5 in LiₓCoO₂ in organic solvent electrolytes. FIG. 15 depicts a scan, from the 25^{th} cycle and at a rate of 1 C, where the observed capacity was 105 mAh/g, consistent with aspects of the present disclosure.

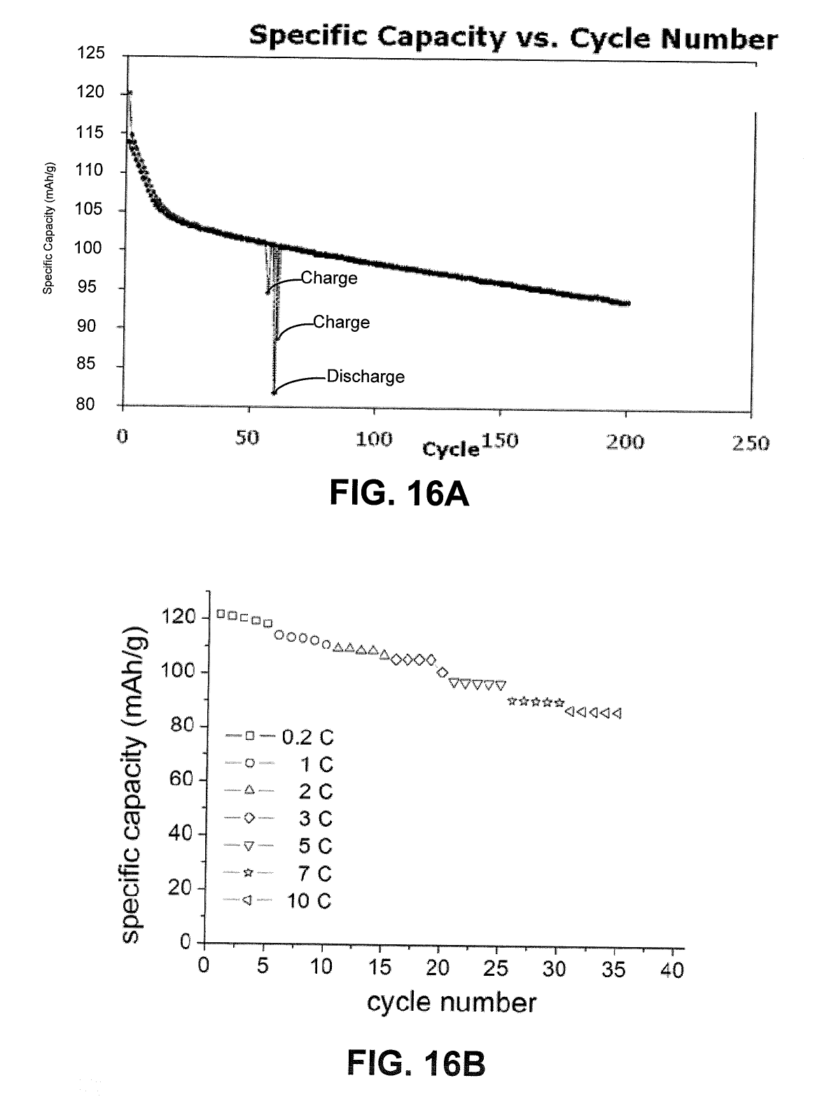

Experiments were conducted that involved cycling such an electrode between these limits at a rate of 1 C. FIG. 16A depicts results of cycling, covering 200 cycles, consistent with aspects of the present disclosure. Both the measured capacity and the Coulombic efficiency of each cycle are shown. The efficiency increased to very high values after the first few cycles, so that the measured capacity hardly changed at all.

Because of these very attractive results, the influence of the current upon the capacity during cycling was investigated, as depicted in FIG. 16B. It can be seen that the LiₓCoO₂ electrode maintained an attractive capacity even to quite high rates in these aqueous electrolyte cells.

Aspects of the present disclosure relate to a variety of electrode materials and related alloys in addition to those expressly mentioned herein. A few additional non-limiting examples are presented hereafter. It will be appreciated that variations can be made therefrom. For instance, alloys and/or doping of the materials can be used to control the potential at which various materials react with protons (e.g., hydrogen cations).

Additional experiments have been performed using commercial carbon-coated LiFePO₄ powder. Electrodes were prepared using stainless steel mesh current collectors. These electrodes were tested in an aqueous solution with 2 M Li₂SO₄ at neutral PH. The performance was shown to be excellent and to provide reversible intercalation of lithium when cycled in a basic solution of LiOH.

Consistent with other aspects of the present disclosure, experiments were performed regarding the cycling behavior of commercial AB₅ type metal hydrides in aqueous electrolytes, some of which included lithium ions. Experimental results suggest that electrolytes containing KOH perform well, which is consistent with their use in metal.

Other aspects of the present disclosure relate to full cell cycling experiments of hybrid aqueous batteries. A particular full cell cycling experiment involved a reaction of lithium ions with LiFePO₄ positive electrodes and the reaction of hydrogen ions with AB₅ negative electrodes.

Aspects of the present disclosure are directed toward optimizing the energy storage capacity of such hybrid aqueous batteries. Careful selection of positive and negative electrode materials to match aqueous electrolytes and pH values allows for an efficient battery cell to be implemented that is also stable. For instance, reaction potentials of metal hydrides can be modified by changing the specific composition (e.g., based upon composition-dependent crystallographic lattice parameters).

Specific applications and background details relative to the present invention are discussed above, in the description below and throughout the references cited herein.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For instance, such changes may include various electrode combinations including alloys. Other changes include implementing aspects of the invention with teachings disclosed in the underlying provisional application and/or those teachings in the incorporated references. Such modifications and changes do not depart from the true spirit and scope of the present invention, which is set forth in the following appended claims.

What is claimed is:

1. A rechargeable lithium ion and hydrogen ion electrochemical cell comprising:
a first electrode configured to store energy by interacting with lithium cations;
a second electrode configured to store energy by interacting with hydrogen cations; and
an aqueous electrolyte configured to separate the first electrode from the second electrode and to provide both the lithium cations and the hydrogen cations.

2. The electrochemical cell of claim 1, wherein the aqueous electrolyte has a stability limit and the first electrode has a reaction potential that is within stability limit of the aqueous electrolyte.

3. The electrochemical cell of claim 1, wherein the aqueous electrolyte has a stability limit and the second electrode has a reaction potential that is within stability limit of the aqueous electrolyte.

4. The electrochemical cell of claim 1, wherein the aqueous electrolyte has a stability limit that is defined by a voltage necessary to separate oxygen and hydrogen from one another.

5. The electrochemical cell of claim 1, wherein the first electrode is one of LiCoO₂ and LiFePO₄.

6. The electrochemical cell of claim 1, wherein the second electrode includes one of HxTiNi, HxTi2Ni, HxLaNi5, HxFeTi, HxMg2Ni, and a β-Ti alloy.

7. The electrochemical cell claim 1, wherein the second electrode includes alloys of one of HxTiNi, HxTi2Ni, HxLaNi5, HxFeTi, HxMg2Ni, and β-Ti.

8. The electrochemical cell of claim 1, wherein the first electrode is configured to react with the lithium cations as part of an intercalation process.

9. The electrochemical cell of claim 1, wherein the aqueous electrolyte includes one of LiNO₃, Li₂SO₄ and LiClO₄.

10. A battery system comprising:
a plurality of hybrid energy storage cells, each cell including
a positive electrode configured to store energy by interacting with lithium cations;
a negative electrode configured to store energy by interacting with non-lithium cations; and
an aqueous electrolyte configured to separate the positive electrode from the negative electrode and to provide both the lithium cations and the non-lithium cations.

11. The battery system of claim 10, wherein the non-lithium cations include hydrogen cations.

12. The battery system of claim 10, wherein the negative electrode is configured to have a reaction potential that is within a stability limit of the aqueous electrolyte.

13. The battery system of claim 10, wherein the positive electrode is configured to have a reaction potential that is within a stability limit of the aqueous electrolyte.

14. The battery system of claim 10, wherein the positive and negative electrodes are configured to have a reaction potential that is sufficiently low to prevent separation of hydrogen from oxygen within the aqueous electrolyte.

15. A method of manufacturing a hybrid energy storage cell, the method comprising:
providing a structure that includes an aqueous electrolyte that provides both lithium cations and hydrogen cations;
providing a first electrode that includes a first material designed to store energy by interacting with the lithium cations; and
providing a second electrode that includes a second material to store energy by interacting with hydrogen cations and that is electrically separated from the first electrode by the aqueous electrolyte.

16. The method of claim 15, further including the step of forming the first electrode by coating a conductive electrode material with the first material.

17. The method of claim 15, wherein the first material is one or more of LiCoO₂ and LiFePO₄.

18. The method of claim 15, further including the step forming the second electrode by coating a conductive electrode material with the second material.

19. The method of claim 15, wherein the second material includes one or more of HxTiNi, HxTi2Ni, HxLaNi5, HxFeTi, HxMg2Ni, and a β-Ti alloy.

20. The method of claim 19, further including the step of alloying the second material with another material.
